(19) United States
(12) Patent Application Publication
(10) Pub. No.: US 2023/0011640 A1
(43) Pub. Date: Jan. 12, 2023

(54) METHODS FOR RECOVERING ORGANIC SALTS FROM INDUSTRIAL PROCESS STREAMS

(71) Applicant: CYTEC INDUSTRIES INC., PRINCETON, NJ (US)

(72) Inventors: Scott GRIFFIN, Glen Ellyn, IL (US); Joseph CALBICK, Weston, CT (US); Dannon STIGERS, Milford, CT (US)

(73) Assignee: CYTEC INDUSTRIES INC., PRINCETON, NJ (US)

(21) Appl. No.: 17/783,844

(22) PCT Filed: Dec. 7, 2020
(86) PCT No.: PCT/US2020/063644

§ 371 Date: Jun. 9, 2022

Related U.S. Application Data
(60) Provisional application No. 62/947,562, filed on Dec. 13, 2019.

(51) Int. Cl. C01F 7/473

(52) U.S. Cl. CPC C01F 7/473

(57) ABSTRACT

Methods are provided for improved recovery of organic salts, such as ionic liquids or organic salts comprising quaternary organic cations, in an industrial alumina production process, such as the Bayer process. These methods include (i) using an organic salt for the removal of impurities in an industrial process for the production of alumina; (ii) subjecting the spent organic salt to a recycling operation that generates at least one exit stream having a measureable amount of the organic salt {e.g., by entrainment or by solubility of the organic salt in the exit stream); (iii) collecting and treating the exit stream (s) with an inorganic salt, in an amount effective to induce phase separation; and (iv) recovering the organic phase containing the recovered organic salt. These methods and compositions allow alumina refinery plants to use organic salts for removal of industrial process streams in an economical manner, due to the efficient recovery of the organic salt.

### FIELD OF THE INVENTION

This invention relates to processes for recovering organic salts, such as ionic liquids or liquid organic salts, from industrial process streams such as process streams in the Bayer alumina extraction process or the Sinter process. The methods involve the addition of inorganic salts to an aqueous organic salt solution, to induce separation and/or precipitation of the organic salt. The separated organic salt may then be removed by conventional separation processes.

### BACKGROUND OF THE INVENTION

Particular organic salts, often referred to as “ionic liquids,” have been investigated as reusable (i.e., “green”) solvents and reagents in industrial processes. An ionic liquid (IL) is a salt in the liquid state. Whether these organic salts are being used for extraction of desirable products, extraction of impurities, or as solvents for reactions, over time, impurities and/or products may build up in the system and lead to system failure.

Typical processes that use organic salt to extract impurities include processes to convert bauxite to alumina, such as the Bayer process or the Sinter process.

Bauxite is the basic raw material for almost all manufactured aluminum compounds. In the course of production of aluminum compounds, bauxite can be refined to aluminum hydroxide and subsequently to alumina, e.g., using the Bayer process, the Sinter process, as well as combinations or variations thereof. The mineralogical composition of bauxite can impact the method of processing.

Bauxite is the generic name for naturally occurring ores that are rich in hydrated aluminium oxides. The ores are composed of gibbsite (Al₂O₃.3H₂O), boehmite (γ-AlO(OH)) and diaspore (α-AlO(OH)), combined with iron oxides, such as goethite (FeO(OH)) and haematite (Fe₂O₃), as well as other impurities such as kaolinite clays.

The Bayer process is a hydrometallurgical system for refining naturally occurring bauxite ores into anhydrous alumina, Al₂O₃. First proposed in 1888 by Karl Josef Bayer, it is currently the leading industrial means of alumina production. It is a multi-step, continuous process, comprising of grinding, pre-desilication, digestion, decantation, filtration, precipitation and calcination.

The production of alumina from bauxite can be achieved by the Bayer Process, Sinter Process or a combination of the two. In the Bayer process, mined bauxite is first ground to fine solids, and then typically, pre-desilicated to convert most of clays to sodalite. This pre-desilicated bauxite then undergoes digestion. During the digestion, the bauxite is treated with caustic soda (NaOH), known as the Bayer liquor, at high temperature and pressure to produce dissolved sodium aluminate. The solid-liquid separation or decantation occurs in the settler, where high concentrated solid slurry (30 to 50%) settles in the bottom of the settling tank, while the supernant liquor, containing low concentration of mud remains in the top layer of the settler. The settled slurry (also known as red mud) is subsequently pumped to a series of decanters (e.g., washers), in order to recover the residual caustic soda in the red mud that has been settled. The spent Bayer liquor containing caustic soda used for the digestion is typically recycled.

In the Sinter process, the bauxite residue (or Bayer “red mud”) is combined with lime and heated (calcined) to 1200° C. prior to leaching with sodium hydroxide solution which generates a sodium aluminate liquor containing insoluble “sinter mud”.

The mud slurry generated in the above processes is then treated with flocculants in thickeners where the mud solids are flocculated and separated from the saturated liquor by gravity settling. At this point, the Sinter process often requires another step where a desilication additive such as lime is added to the overflow liquor to remove soluble silica species from the liquor. The slurry is treated with flocculants and fed to a desilication settler to remove insoluble desilication products and produce a liquor.

The liquor is further purified in a filtration process to remove suspended fine solids and other impurities. The purified, or pregnant liquor, is then cooled and seeded with alumina trihydrate crystals or neutralized with CO₂ gas in a precipitation process to produce alumina trihydrate which is separated from the liquor. Then the alumina trihydrate is subjected to trihydrate calcination to produce the final product, alumina. Meanwhile the separated Sinter process liquor is recycled. In the Sinter process, the clarified liquor after the precipitation of alumina trihydrate (also known as spent liquor) is treated with organic salts. Moreover, that liquor can subsequently be evaporated to remove water creating a “strong liquor,” which can be treated with the organic salts as well.

Bauxite ore typically contains organic and inorganic impurities. The organic impurities may include polybasic acids, polyhydroxy acids, alcohols and phenols, benzenecarboxylic acid, humic and fulvic acids, lignin, cellulose, and other carbohydrates. Alkaline, oxidative conditions such as those in the Bayer process and Sinter process, break-down these organic impurities to form other impurity compounds such as sodium salts of formic, succinic, acetic, lactic and oxalic acids. A particularly problematic impurity is sodium oxalate. For example, spent Bayer liquor containing caustic soda used for the digestion as well as the separated Sinter process liquor contain the impurity compounds such as sodium salts of formic, succinic, acetic, lactic and oxalic acids. Both the spent liquor and strong liquor can be treated with organic salts.

Sodium oxalate has a low solubility in caustic solutions. Thus, if not controlled, it tends to precipitate in an acicular (fine, needle-like) form in regions of the Bayer process and Sinter process where there is an increase in causticity or decrease in temperature. These fine sodium oxalate needles can nucleate alumina trihydrate and inhibit its agglomeration, resulting in fine, undesirable gibbsite particles which are difficult to classify and less than ideal for calcination.

During the calcination stage, oxalate can decompose to leave fragile alumina particles having high sodium content, which in turn can increase the cost of aluminum production and subsequently produce undesirable levels of CO₂ emissions. Additionally, due to the formation of sodium oxalate: (1) scale growth may be increased; (2) there may be an increase in liquor boiling point; (3) caustic losses may be observed in the circuit (due to the formation of organic sodium salts); and/or (4) the Bayer liquor viscosity and density may be increased, resulting in increased material transport costs.

The presence of oxalate and/or other organic species such as glucoisosaccharinate, gluconate, tartrate, and mannitol may decrease gibbsite precipitation yield. The presence of gluconate may reduce gibbsite growth rate. The presence of medium and high molecular weight humic substances in Bayer liquor may cause liquor foaming and interfere with red mud flocculation. High levels of organic material in Bayer liquor may also result in a decrease in coagulation efficiency and supernatant clarity during the red mud processing. Alumina trihydrate containing high levels of organic matter also tends to produce a final product having an undesirably high level of coloration and/or impurity level.

As the Bayer process is cyclic, organic matter entering the process stream tends to accumulate with each cycle of the process, with steady state impurity concentration determined by process input and output streams. Both the red mud circuit and the gibbsite product are exit routes for organic impurities in the Bayer process.

It has been shown that certain organic salts i.e., “ionic liquids,” can be utilized to remove or extract impurities, such as those formed in a Bayer process stream. A “Bayer process stream” is a liquid stream generated during the Bayer process and includes the various Bayer process streams mentioned above, including thickener overflow, pregnant liquor, spent liquor and strong liquor streams. Ionic liquids may be highly effective for removing impurities from an industrial process stream. For example, when employed in the Bayer process, ionic liquids may be implemented in the form of an impurity removal unit operation that is added to the Bayer process at any point after thickener through to digestion, with the preferred location being directly after the final alumina trihydrate precipitation stage. For example, when an organic salt solution including an impurity-extracting amount of an organic salt is intermixed with a Bayer process stream, impurities are removed from the Bayer process stream and the caustic (OH⁻) concentration may be increased in the Bayer liquor through anion exchange during the impurity extraction, which creates additional economic benefit to the end-user. For example, water may be removed from the Bayer process stream and may be extracted into the phase containing the organic salt, particularly when the organic salt is associated with significant amounts of hydroxide anions. The phases can then be separated, thereby reducing the level of water in the Bayer process stream.

Organic and/or inorganic impurities from a Bayer stream can be extracted into the extractant liquid phase. For example, in an embodiment in which the cationic salt is tetrabutylammonium hydroxide, about 48.2 weight percent of oxalate/succinate and about 85.6, 91.7, and 96.1 weight percent of acetate, formate, and chloride ions, respectively may be removed from Bayer liquor. The total organic carbon content (TOC) may be reduced by about 63.0 weight percent in Bayer liquor. Also, a strong visual reduction in the color of the Bayer Liquor after contact with the quaternary organic cation-rich solution may be observed. In another embodiment in which the cationic salt is tetrabutylphosphonium hydroxide, about 53.38 weight percent of oxalate/succinate, 83.93, 91.93, 96.48 weight percent of acetate, formate, and chloride ions, respectively, may be removed from a Bayer liquor. The TOC content in the Bayer liquor may be reduced by about 67.7 weight percent.

An embodiment provides a method of purifying a Bayer process stream that comprises providing a liquid phase that comprises an oxalate-extracting amount of an organic salt and intermixing the Bayer process stream with the liquid phase in an amount effective to form a biphasic liquid/liquid mixture. The organic salt comprises a quaternary organic cation, and the liquid phase is at least partially immiscible with the Bayer process stream. The resulting biphasic liquid/liquid mixture contains a primarily Bayer process phase and a primarily organic salt phase. Separation of the primarily Bayer process phase from the primarily organic salt phase forms a separated primarily Bayer process phase and a separated primarily organic salt phase. The intermixing of the oxalate-extracting amount of an organic salt with the Bayer process stream is effective to reduce the concentration of oxalate in the Bayer process stream. This invention is not bound by theory of operation, but it is believed that extraction of water and impurities (such as oxalate) from the Bayer process stream into the liquid phase with which it is intermixed is facilitated by the mixing conditions and the presence of the organic salt in the liquid phase. In some embodiments the intermixing is also effective to reduce the concentration of one or more other impurities in the Bayer process stream, such as an inorganic impurity (e.g., chloride).

The liquid phase extractant contains an organic salt that comprises a quaternary organic cation. Examples of suitable organic salts are described herein and include so-called “ionic liquids.” Examples of quaternary organic cations include phosphonium, ammonium, imidazolium, pyrrolidinium, quinolinium, pyrazolium, oxazolium, thiazolium, isoquinolinium, and piperidinium. Those skilled in the art will understand that the foregoing examples of quaternary organic cations encompass substituted versions thereof, including the following:

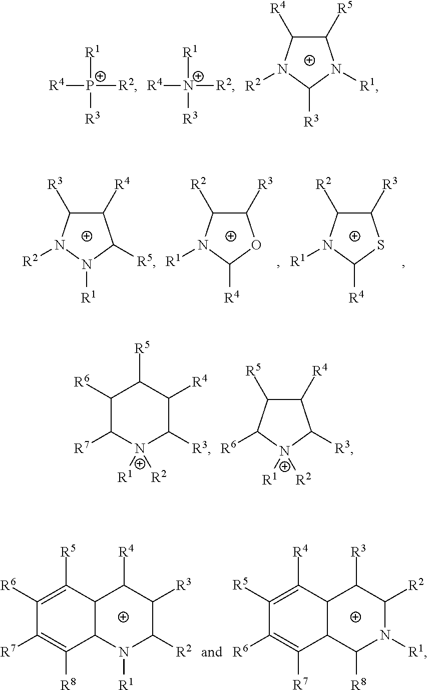

wherein R¹ through R⁸ are each independently selected from a hydrogen, or an optionally substituted C₁-C₅₀ alkyl group, where the optional substituents include one or more selected from alkyl, alkenyl, alkynyl, alkoxyalkyl, carboxylic acid, alcohol, carboxylate, hydroxyl, and aryl functionalities. R1 through R8 each individually comprise from about 1 to about 50 carbon atoms, e.g., from about 1 to about 20 carbon atoms.

The “alkyl” term as used herein can be branched or unbranched hydrocarbon group comprising of 1 to 50 carbon atoms (i.e., methyl, ethyl, n-propyl, isopropyl, n-butyl, isobutyl, t-butyl, pentyl, hexyl, heptyl, octyl, nonyl, decyl, dodecyl, tetradecyl, hexadecyl, etc.). The alkyl group can be unsubstituted or substituted with one or more substituents including, but not limited to, alkyl, alkoxy, alkenyl, halogenated alkyl, alkynyl, aryl, heteroaryl, aldehyde, ketone, amino, hydroxyl, carboxylic acid, ether, ester, thiol, sulfo-oxo, silyl, sulfoxide, sulfonyl, sulfone, halide, or nitro, as described below. The term “alkyl” is generally used to refer to both unsubstituted alkyl groups and substituted alkyl groups; the substituted alkyl groups used herein are described by referring to the specific substituent or substituents. For instance, “alkylamino” describes an alkyl group that is substituted with one or more amino groups, as described below. The term “halogenated alkyl” describes an alkyl group that is substituted with one or more halide (e.g., fluorine, chlorine, bromine, or iodine). When “alkyl” is used in one case and a specific term such as “alkylalcohol” is used in another, it is not meant to suggest that the term “alkyl” does not also refer to specific terms such as “alkylalcohol” and the like. When using a general term such as “alkyl” and a specific term such as “alkylalcohol” it is not implied that the general term does not also include the specific term. This practice is also used for other terms described herein.

The term “alkoxy” denotes an alkyl group bound through a single, terminal ether linkage. The “alkenyl” is a substituted or unsubstituted hydrocarbon group comprising 2 to 50 carbon atoms which contains at least one carbon-carbon double bond. The “alkenyl” term includes any isomers in which the compound may exist. The alkenyl group can be substituted with one or more groups including, but not limited to, alkyl, alkoxi, alkenyl, halogenated alkyl, alkynyl, aryl, heteroaryl, aldehyde, ketone, amino, hydroxyl, carboxylic acid, ether, ester, thiol, sulfo-oxo, silyl, sulfoxide, sulfonyl, sulfone, halide, or nitro, as described below.

The term “halogenated alkyl” as used herein is an alkyl group which is substituted with at least one halogen (e.g., fluoride, chloride, bromide, iodide). The halogenated alkyl can also be unsubstituted, or substituted with one or more groups including, but not limited to, alkyl, alkoxy, alkenyl, halogenated alkyl, alkynyl, aryl, heteroaryl, aldehyde, ketone, amino, hydroxyl, carboxylic acid, ether, ester, thiol, sulfo-oxo, silyl, sulfoxide, sulfonyl, sulfone, halide, or nitro, as described below.

The term “alkynyl” denotes a substituted or unsubstituted hydrocarbon group comprising of 2 to 50 carbon atoms which contains at least one carbon-carbon triple bond. The alkenyl group can be substituted with one or more groups including, but not limited to, alkyl, alkoxi, alkenyl, halogenated alkyl, alkynyl, aryl, heteroaryl, aldehyde, ketone, amino, hydroxyl, carboxylic acid, ether, ester, thiol, sulfo-oxo, silyl, sulfoxide, sulfonyl, sulfone, halide, or nitro, as described below.

The “aryl” term is a hydrocarbon group that comprises of one or more aromatic rings including, but not limited to phenyl, naphtyl, biphenyl, and the like. The term includes “heteroaryl” which is an aromatic group that contains at least one heteroatom within the aromatic ring. A heteroatom can be, but not limited to, oxygen, nitrogen, sulfur, and phosphorus. The aryl group can be unsubstituted, or substituted with one or more groups including, but not limited to, alkyl, alkoxy, alkenyl, halogenated alkyl, alkynyl, aryl, heteroaryl, aldehyde, ketone, amino, hydroxyl, carboxylic acid, ether, ester, thiol, sulfo-oxo, silyl, sulfoxide, sulfonyl, sulfone, halide, or nitro.

The term “aldehyde” refers to a —(CO)H group (where (CO) represents C═O). The term “ketone” refers to a Rx(CO)Ry group, where Rx and Ry can each independently be an alkyl, alkoxy, alkenyl, alkynyl, or aryl, bound to the (CO) group through carbon-carbon bonds. The term “amine” or “amino” refers to a NRaRbRc group, where Ra, Rb, and Rc can each independently be hydrogen, an alkyl, alkoxi, alkenyl, alkynyl, or aryl. The term “hydroxyl” refers to an —OH group. The term “carboxylic acid” refers to a —(CO)OH group.

Examples of quaternary organic cations include trihexyltetradecylphopshonium, tetrabutylphosphonium, tetradecyl(tributyl)phosphonium, 1-Butyl-3-methylimidazolium, tributylmethylammonium, tetrapentylammonium, dimethyl dicoco quaternary ammonium stearamidopropyldimethyl-2-hydroxyethylammonium, ethyltetradecyldiundecyl ammonium tallowalkyltrimethyl ammonium, tetrahexylammonium, butylmethylpyrrolidinium, N,N,N-trimethyl-1-dodecanaminium benzyldimethylcocoalkylammonium, N,N-dimethyl-N-dodecylglycine betaine, 1-octyl-2,3-dimethylimidazolium, tetrabutylammonium, tributyl-8-hydroxyoctylphosphonium, sulfonium and guanidinium. Preferred cations are phosphonium, ammonium, pyrrolidinium and imidazolium.

The quaternary organic cation of the cationic organic salt is typically associated with an anionic counterion or anion. Examples of suitable anions include inorganic anions and organic anions. The anion may a chaotropic anion or a kosmotropic anion. Examples of suitable anions include halide (e.g., fluoride, chloride, bromide, iodide), hydroxyl, alkylsulfate (e.g., methylsulfate, ethylsulfate, octylsulfate), dialkylphosphate, sulfate, nitrate, phosphate, sulfite, phosphate, nitrite, hypochlorite, chlorite, perchlorate, bicarbonate, carboxylate (e.g., formate, acetate, propionate, butyrate, hexanoate, fumarate, maleate, lactate, oxalate, pyruvate), bis(trifluoromethylsulfonyl)imide ([NTF2]−), tetrafluoroborate, and hexafluorophosphate.

The organic salt may comprise any pairing of the quaternary organic cations and anions described herein or generally known in the art. Examples of suitable organic salts include AMMOENG 101®, AMMOENG 110®, trihexyltetradecylphopshonium chloride (Cyphos IL 101®, Cytec Industries, Inc. W. Paterson, N.J.), tetrabutylphosphonium chloride (Cyphos IL 164®, Cytec Industries, Inc. W. Paterson, N.J.), tetradecyl(tributyl)phosphonium chloride (Cyphos IL 167®), 1-Butyl-3-methylimidazolium chloride ([C4mim]Cl), tetrabutylammonium hydroxide ([(C4)4N][OH]), tetrabutylammonium chloride ([(C4)4N]Cl), tributylmethylammonium hydroxide ([(C4)3(C1)N][OH], tetrapentylammonium hydroxide ([(C5)4N][OH]), Adogen 462® (dimethyl dicoco quaternary ammonium chloride), Cyastat SN® (Stearamidopropyldimethyl-2-hydroxyethylammonium nitrate), ethyltetradecyldiundecyl ammonium chloride, Arquad T-50® (Tallowalkyltrimethyl ammonium chloride), tetrahexylammonium bromide, butylmethylpyrrolidinium bis(trifluoromethylsulfonyl)imide, Arquad 12-50H® (N,N,N-Trimethyl-1-dodecanaminium chloride), Arquad DMCB-80® (Benzyldimethylcocoalkylammonium chloride), EMPIGEN BB® detergent (N,N-dimethyl-N-dodecylglycine betaine), 1-Octyl-2,3-dimethylimidazolium chloride, 10 wt % tetrabutylammonium hydroxide dissolved in PEG 900, Aliquat® HTA-1, tributyl-8-hydroxyoctylphosphonium chloride, and tetrabutylphosphonium hydroxide.

AMMOENG 101® is represented by the following formula:

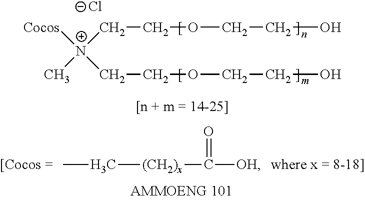

AMMOENG 110® is represented by the following formula:

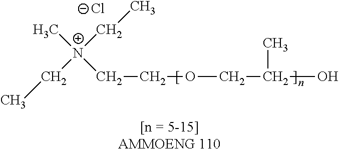

ADOGEN 462® is represented by the following formula:

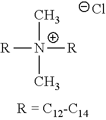

For example, U.S. Pat. No. 7,972,580 discloses a liquid phase that comprises an oxalate-extracting amount of an organic salt (ionic liquid) that is useful as an extractant in a liquid/liquid extraction process for purifying Bayer process streams. In particular U.S. Pat. No. 7,972,580 discloses a method of purifying a Bayer process stream, comprising: providing a liquid phase that comprises an organic salt, the liquid phase including at least 1 wt. % of the organic salt, based on the weight of the Bayer process stream, wherein the organic salt comprises a quaternary organic cation, and wherein the liquid phase is at least partially immiscible with the Bayer process stream. Intermixing the Bayer process stream with the liquid phase in an amount effective to form a biphasic liquid/liquid mixture, wherein the biphasic liquid/liquid mixture comprises a primarily Bayer process phase and a primarily organic salt phase. At least partially separating the primarily Bayer process phase from the primarily organic salt phase to form a separated primarily Bayer process phase having a reduced oxalate concentration and a separated primarily organic salt phase. The intermixing is effective to reduce the concentration of oxalate in the Bayer process stream by extraction from the Bayer process stream into the primarily organic salt phase.

However, to minimize costs it is desirable to recycle the organic salt utilized to remove impurities. A few methods have been reported regarding the recycling or regeneration of organic salts, i.e., ionic liquids. Hydrophobic organic salts have been regenerated by extracting impurities therefrom with a solvent that the organic salt is not soluble in, but the impurities are. However, the process has not been shown to be completely effective, since the organic salts lose activity over multiple regeneration cycles. In another method of regeneration, sodium chloride has been shown to be an effective extractant for lactic acid coordinated to quaternary ammonium in an organic solvent. This method of regeneration operates on simple ion exchange. Additional method of regeneration of certain organic salts include, but are not limited to, use of supercritical carbon dioxide, pervaporation, distillation of impurities, use of alkaline solutions, electrolysis and nanofiltration. Nevertheless, the processes known to date do not have the scale necessary for large industrial applications.

U.S. Pat. No. 8,435,411 to Lean et al. discloses a method of recycling or regeneration of organic salts, i.e., ionic liquids, comprising: providing an impurity-loaded organic salt solution comprising oxalate; and intermixing the impurity-loaded organic salt solution with a stripping solution to form a biphasic mixture, wherein the intermixing is effective to reduce a concentration of oxalate in the impurity-loaded organic salt solution, thereby removing impurities from the organic salt solution and forming an impurity reduced organic salt solution phase and a primarily stripping solution phase, wherein organic salt, i.e., “ionic liquid”, present in the impurity-loaded organic salt solution comprises: a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium; and an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF2]⁻), tetrafluoroborate, and hexafluorophosphate. In general, the stripping solution facilitates the removal of impurity from the impurity-loaded organic salt. For example, the stripping solution may contain a compound having an anion selected from a halide (e.g., fluoride, chloride, bromide, iodide), hydroxyl, alkylsulfate (e.g., methylsulfate, ethylsulfate, octylsulfate), dialkylphosphate, sulfate, nitrate, phosphate, sulfite, nitrite, hypochlorite, chlorite, perchlorate, carbonate, bicarbonate, carboxylate (e.g., formate, acetate, propronate, butyrate, hexanoate, fumarate maleate, lactate, oxalate, pyruvate), bis(trifluoromethylsulfonyl)imide ([NTF₂]⁻), tetrafluoroborate and hexafluorophosphate. The compound present in the stripping solution may include any cation capable of bonding with the aforementioned anions. The compound(s) present in the stripping solution may include, but are not limited to: sodium chloride, potassium bromide, sodium bisulfate, sodium hydroxide, sodium nitrate, sodium bicarbonate, sodium nitrite, and the like. The process optionally intermixes the impurity reduced organic salt solution with a wash solution to form a third biphasic mixture, wherein the intermixing is effective to form a washed organic salt phase and a wash solution phase, wherein the wash solution includes a compound having an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate, e.g., sodium hydroxide.

FIG. 1 shows a flowchart of a process to remove impurities from a Bayer process stream arrived at by combining the extraction of U.S. Pat. No. 797,250 B2 and the stripping and washing of U.S. Pat. No. 8,435,411 B2. The process has solvent extraction operations where a process stream is intermixed with an organic extracting phase and the phases are allowed to separate. The loaded extracting phase is then further processed by intermixing with a stripping solution, allowing to separate, and finally intermixing with a regeneration (washing) solution. After the final separation from the regeneration (also known as washing) solution in a regeneration (washing) step, the extracting phase is recycled back to the process. During this process, several exit streams are generated: the treated Bayer process solution, the stripping stage exit solution and the regeneration (washing) stage exit stream. These exit streams contain measureable amounts of the organic salt extraction phase within them, either by entrainment or by solubility of the organic salt extraction phase in the exit stream.

It would be desirable to recover at least a portion of these measureable amounts of the organic salt, such as ionic liquids, to provide an efficient and economical process on an industrial scale from these exit streams.

### SUMMARY OF THE INVENTION

Described herein are processes for the recovery of organic salts (ionic liquids) which can be applied to industrial processes for the processing of alumina. The industrial process for the production of alumina may be selected from the group consisting of a Bayer process, a Sinter process, or any modifications or combinations thereof. For example, during such industrial processes an organic phase comprising the organic salt is contacted with aqueous Bayer liquor streams to remove certain impurities, e.g., oxalate impurities, from the Bayer liquor streams. This results in a variety of primarily aqueous exit streams which contain portions of the organic acid. Such aqueous streams may be, for example, any one or more of a Bayer liquor exit stream resulting from treating Bayer liquor with organic phase comprising the organic salt, i.e., ionic liquid, a stripping stage exit solution resulting from cleaning the organic phase that was used to treat the Bayer liquor process solution, and the regeneration stage exit solution resulting from regenerating (washing) the organic phase that was subjected to stripping.

An ionic liquid (IL) is a salt in the liquid state. In some contexts, for purposes of the present specification the term is defined as organic salts whose melting point is below 100° C. (212° F.). Preferably the ionic liquid (IL) is an organic salt whose melting point is below 25° C. (77° F.), also known as a room temperature ionic liquid for purposes of the present specification.

In accordance with the invention, described herein are methods for the treatment of these exit streams to recover the organic salts (ionic liquids) that would be otherwise be lost. The inventive method adds inorganic salts to an aqueous organic salt solution to induce phase separation/precipitation of an organic phase containing the organic salt (ionic liquid). In particular, the invention further processes one or more of the exit streams by adding inorganic salt to induce phase separation/precipitation and then letting the phases separate.

The invention relates to certain methods for recovering at least one organic salt impurity, in a process for the production of alumina, from an aqueous solution comprising organic salt, the method comprising:
providing an aqueous phase, wherein the aqueous phase comprises at least one organic salt and wherein the at least one organic salt is soluble in the aqueous phase;
intermixing the aqueous phase with an amount of inorganic salt to form a biphasic mixture, wherein the intermixing is effective to reduce a concentration of organic salt in the aqueous phase; and
forming an organic salt reduced aqueous phase and a primarily organic salt phase,
wherein the organic salt present in the aqueous phase and the primarily organic salt phase comprises:
a cation selected from the group consisting of phosphonium, ammonium, sulfonium, imidazolium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium; and
an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

The invention also relates to certain methods for recovering an organic salt in a process for the production of alumina, comprising:

(a) contacting an organic liquid phase comprising at least one organic salt with an aqueous solution at least partially immiscible in the organic liquid phase to produce a biphasic liquid/liquid mixture comprising a primarily aqueous phase and a primarily organic salt phase, wherein the intermixing is effective to transfer a portion of the at least one organic salt to the primarily aqueous phase,
(b) at least partially separating the primarily aqueous phase from the primarily organic salt phase to form a separated primarily aqueous phase and a separated primarily organic salt phase; and
(c) intermixing the separated primarily aqueous phase with an amount of an inorganic salt to form a biphasic mixture, wherein the amount of inorganic salt is effective to form a recovered organic phase, comprising a recovered portion of said at least one organic salt, and a recovered aqueous phase,
wherein the inorganic salt has at least one anion selected from citrate³⁻, sulfate²⁻, phosphate³⁻, OH⁻, F⁻, Cl⁻, Br⁻, I⁻, NO₃⁻, ClO₄⁻ and at least one cation selected from N(CH₃)₄⁺, NH₄⁺, Cs⁺, Rb⁺, K⁺, Na⁺, Li⁺, H⁺, Ca⁺, Mg²⁺, Al³⁺; and
   (d) optionally recycling the recovered organic phase to the industrial process;
wherein the at least one organic salt comprises a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium, and an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

The invention also provides a method for recovering an organic salt in an industrial process for the production of alumina, comprising:

(a) contacting an organic salt liquid phase comprising at least one organic salt with an aqueous process stream of a process for the production of alumina for the removal of at least one impurity from the aqueous process stream and transfer of the at least one impurity to a primarily organic phase comprising the organic salt and the at least one impurity, and producing an impurity laden organic salt stream comprising the primarily organic phase, wherein the at least one impurity comprises oxalate;
(b) recycling the organic salt, wherein the recycling comprises removing at least a portion of the at least one impurity from the impurity laden organic salt stream, wherein the contacting and/or the recycling generate at least one aqueous exit stream which comprises a portion of the organic salt from the organic salt liquid phase;
(c) intermixing the at least one aqueous exit stream with an amount of an inorganic salt to form a biphasic mixture and allowing the biphasic mixture to form an organic salt reduced aqueous solution phase and a primarily organic salt phase, wherein the amount of the inorganic salt in the biphasic mixture is effective to form the organic salt reduced aqueous solution phase and a primarily organic salt phase, wherein the primarily organic salt phase comprises the portion of the organic salt; and
(d) recovering the primarily organic salt phase;
wherein the at least one organic salt comprises a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium, and an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

Typically one of the organic liquid phase and the aqueous solution comprises a first concentration of oxalate, and another of the organic liquid phase and the aqueous solution has a second concentration of oxalate which is an absence of oxalate or a lower concentration of oxalate than the first concentration of oxalate, wherein the intermixing is effective to transfer a portion of the oxalate from the phase having the first concentration of oxalate to the phase having the second concentration of oxalate.

The intermixing is effective to reduce a concentration of organic salt in the aqueous phase, thereby removing the organic salt from the aqueous solution comprising organic salt and forming an organic salt reduced aqueous solution phase and a primarily organic salt phase.

The separate organic phase containing the organic salt can be recovered by conventional liquid-liquid separation techniques, including but not limited to, decantation, centrifugation, coalescence, filtration, distillation, and adsorption/desorption techniques.

The methods described herein may also be practiced using the additional step of performing at least one additional purification operation on the organic phase.

After the methods are used, the recovered organic phase may be recycled back into the process for the production of alumina.

The invention may be used to treat various industrial process streams, including those from the Bayer process or the Sinter process. Thus, typically the aqueous solution comprising organic salt from a process for the production of alumina is an aqueous solution comprising organic salt from the Bayer process for the production of alumina or the Sinter process for the production of alumina. Such aqueous solution comprising organic salt from the Bayer process for the production of alumina or the Sinter process for the production of alumina comprise oxylate.

### BRIEF DESCRIPTION OF THE DRAWINGS

FIG. 1 is a flowchart showing a general overview of the recycling and recovery of organic salts that have been used to remove impurities from an industrial process, such as the Bayer process, without additional organic phase recovery of the present invention, showing the losses of organic salts in various exit streams.

FIG. 2 is a flowchart showing a method of the invention for recycling and recovery of spent organic salts, which includes extraction, stripping and regeneration operations, with additional organic phase recovery of the present invention for treating exit streams with organic salts, to provide improved recovery of organic acids.

### DETAILED DESCRIPTION OF THE INVENTION

The Bayer process, or other alumina production processes, generate various industrial process streams, which may be further treated, e.g., for impurity removal, etc. and recycled. The impurities generated in these processes vary depending on the composition of the bauxite ore. It would be advantageous to use organic salts (e.g., ionic liquids or organic salts comprising a quaternary organic cation) to remove these impurities during alumina production prior to recycle of the alumina production process stream. For example, the methods of U.S. Pat. No. 7,972,580 (which is hereby incorporated by reference in its entirely) use organic salts to remove undesired constituents, such as an oxalate salt, from Bayer process streams, e.g., Bayer liquor stream, before recycle of the Bayer process streams, e.g., Bayer liquor stream.

However, treating the Bayer process streams, e.g., Bayer liquor stream, with the organic salts in an extraction stage makes a cleaned Bayer process streams, e.g., Bayer liquor stream, and a spent impurity laden organic salt stream.

It is beneficial to recover and reuse the organic salts from the spent impurity laden organic salt stream by recycling the organic salts.

For purposes of this specification “recycling the organic salts” includes treating the spent organic salts, and removing impurities such that they may be used again. For example, hydrophobic organic salts have been regenerated by extracting impurities therefrom with a solvent that the organic salt is not soluble in, but the impurities are soluble.

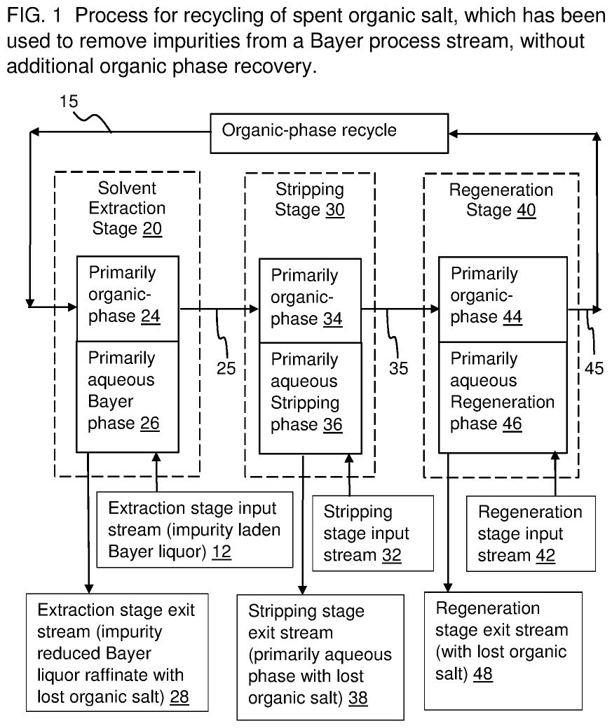

For example, the organic salt recycling operation may comprise one or more of an extraction stage, a stripping stage and a regeneration stage. As mentioned above, FIG. 1 shows a flowchart of a process to remove impurities from a Bayer process stream arrived at by combining the extraction of U.S. Pat. No. 797,250 B2 and the stripping and washing of U.S. Pat. No. 8,435,411 B2 (which is hereby incorporated by reference in its entirely).

Each stage of the recycle operation may generate one or more “exit streams” as shown in FIG. 1, e.g., (i) an impurity reduced Bayer liquor exit stream (raffinate with lost extractant (organic salt)), (ii) a stripping stage exit stream with lost extractant (organic salt), and (iii) regeneration stage exit stream with lost extractant (organic salt). Thus, these exit streams will be contaminated with the organic salts. As a result of these exit streams containing the organic salts there is poor recovery of the organic salts.

A Bayer process stream is a liquid stream generated during the Bayer process and includes the various Bayer process streams mentioned above, including thickener overflow, pregnant liquor, spent liquor and strong liquor streams. In general terms, the purification methods described herein are liquid/liquid extractions that involve extracting undesired constituents (e.g., oxalate) from a Bayer process stream by intermixing with an extractant that is at least partially immiscible with the Bayer process stream, then separating the resultant phases. It has been found that liquid extractants that contain an organic salt are highly effective for extracting undesired impurities. The methods described herein may be implemented in the form of an impurity removal unit operation that is added to the Bayer process at any point after thickener through to digestion, with the preferred location being directly after the final alumina trihydrate precipitation stage.

Examples of impurities that may be removed include, but are not limited to, organic species (e.g., oxalate, formate, acetate and humates) and/or inorganic species (e.g., those that decrease the alumina trihydrate purity such as chloride, sulfate, gallium oxides and/or gallium hydroxides). In addition to removing the undesirable anionic impurities from the process, the caustic (OH⁻) concentration can be increased in the Bayer liquor through anion exchange during the impurity extraction, creating additional economic benefit to the end-user. For example, water may be removed from the Bayer process stream may be extracted into the liquid phase, particularly when the cationic organic salt is associated with significant amounts of hydroxide anions. The phases can then be separated, thereby reducing the level of water in the Bayer process stream.

Organic and/or inorganic impurities from a Bayer stream can be extracted into the extractant liquid phase. For example, in an embodiment in which the cationic salt is tetrabutylammonium hydroxide, about 48.2 weight percent of oxalate/succinate and about 85.6, 91.7, and 96.1 weight percent of acetate, formate, and chloride ions, respectively may be removed from Bayer liquor. The total organic carbon content (TOC) may be reduced by about 63.0 weight percent in Bayer liquor. Also, a strong visual reduction in the color of the Bayer Liquor after contact with the quaternary organic cation-rich solution may be observed. In another embodiment in which the cationic salt is tetrabutylphosphonium hydroxide, about 53.38 weight percent of oxalate/succinate, 83.93, 91.93, 96.48 weight percent of acetate, formate, and chloride ions, respectively, may be removed from a Bayer liquor. The TOC content in the Bayer liquor may be reduced by about 67.7 weight percent.

The term “impurities” may refer to compounds of interest to a user or compounds that may contaminate an industrial process stream. Impurities include, but are not limited to, organic species and/or inorganic species. Specific impurities include, but are not limited to oxalate, formate, acetate, humates, and humate decomposition products, fluoride, chloride, bromide, phosphate, metals, acetate, sulfate, gallium oxides and/or gallium hydroxides, and combinations thereof.

An embodiment provides an organic salt phase, comprising a quaternary organic cation and at least one organic impurity selected from oxalate, formate, acetate, and organic carbon. The amount of organic impurity may vary over a broad range, e.g., the amount of organic impurity is in the range of about 0.0001% to about 5%, by weight based on total weight of organic salt phase. The amount of quaternary organic cation may be similar to that described elsewhere herein for use in the methods described herein. Even though the organic salt phase contains one or more impurities, it is still useful as a liquid phase extractant in situations in which it contains a lower level of impurities that the Bayer process stream.

For example, in an embodiment, the organic salt phase may be a separated organic salt phase that contains an organic impurity, an inorganic impurity and/or additional water, as a result of the extraction from the Bayer process stream as described herein. For example, in an embodiment, the separated organic salt phase contains oxalate and at least one organic impurity selected from formate, acetate, and organic carbon. The separated organic salt phase may contain various amounts of impurities, depending on the extent of extraction and the level of impurities in the Bayer process phase. In some cases the level of impurities in the separated organic salt phase is relatively low, such that the separated organic salt phase can be used as a liquid phase extraction in the manner described herein. It is not necessary that such an organic salt phase be obtained from a separated organic salt phase, but in many cases such use will be efficient and cost effective.

FIG. 1 is a flowchart showing a general overview of the recycling and recovery of organic salts that have been used to remove impurities from an industrial process, such as the Bayer process, without additional organic phase recovery of the present invention, showing the losses of organic salts in various exit streams.

As illustrated in FIG. 1, to use organic salts to remove undesired constituents, such as an oxalate salt, from a Bayer process input stream 12, the Bayer process input stream 12 is intermixed with an organic extracting stream 15 in a solvent extraction stage 20 and is allowed to separate to form a primarily organic phase 24 and a primarily aqueous phase 26 which are at least partly immiscible in each other. The organic extracting stream 15 acts as a solvent for the impurities from the Bayer process input stream 12. Thus, the impurities from the Bayer process input stream 12, e.g. oxalates, transfer from the primarily aqueous phase 26 to the primarily organic phase 24. Then the organic phase 24 discharges as a primarily organic phase exit stream 25. Meanwhile the primarily aqueous Bayer-phase 26 discharges as the treated Bayer liquor exit stream 28. The treated Bayer liquor exit stream 28 contains raffinate (liquid, namely impurity reduced Bayer Liquor, from which impurities have been removed by solvent extraction) and lost extractant, namely a portion of the organic salt.

Thus, in the extraction stage 20 is performed a method comprising providing the organic salt solution (organic extracting stream 15) that comprises an impurity-extracting amount of an organic salt, wherein the organic salt solution is at least partially immiscible with an industrial process stream comprising impurities; intermixing the industrial process stream (Bayer process input stream 12) with the organic salt solution (organic extracting stream 15) to form a first biphasic mixture which is allowed to separate to form a primarily organic phase 24 and a primarily aqueous phase 26 which are at least partly immiscible in each other. The intermixing is effective to reduce the concentration of impurities in the industrial process stream to form a phase containing an impurity-loaded organic salt solution (primarily organic phase exit stream 25) and a phase containing an impurity reduced industrial process stream (primarily aqueous phase 26).

Preferably, the organic salt is an ionic liquid. An ionic liquid (IL) is a salt in the liquid state. As used herein, the term organic salts as well as “ionic liquid” or “room-temperature ionic liquids” (RTILs) may include organic salts that are composed only of ions and have a melting point below about 0° C. and boiling points in the about 200° C. to about 500° C. range). Preferably the ionic liquid (IL) is an organic salt whose melting point is below 25° C. (77° F.), also known as a room temperature ionic liquid for purposes of the present specification. The ionic liquids (also termed interchangeably in this specification as organic salts) disclosed herein may be utilized as solvent which is an extractant to remove, or otherwise extract, impurities from an industrial process stream.

The primarily organic phase stream 25 from the extraction stage 20 is then further processed by intermixing with a stripping solution input stream 32 in the stripping stage 30 and then is allowed to undergo phase separation to form a primarily organic stripping phase 34 and a primarily aqueous stripping phase 36. The primarily organic stripping phase 34 and the primarily aqueous stripping phase 36 are at least partly immiscible in each other. The stripping solution input steam 32 acts as a solvent for the impurities from the primarily organic phase stream 25, e.g. oxalates. Thus, the impurities from the primarily organic phase 34 transfer from the primarily organic phase 34 to the primarily aqueous phase 36. Then the primarily organic stripping phase 34 discharges as a primarily organic phase stream 35. Meanwhile the primarily aqueous stripping-phase 36 discharges as the stripping exit stream 38. Thus, the stripping stage removes impurities from the impurity-loaded organic salt solution by intermixing the impurity-loaded organic salt solution with a stripping solution to form the biphasic mixture, wherein the intermixing effectively reduces the concentration of impurities in the impurity-loaded organic salt, thereby removing impurities from the organic salt and forming an impurity-reduced organic salt solution phase (primarily organic stripping phase 34) and the stripping solution phase (primarily aqueous phase 36). Typically, the impurities comprise an impurity selected from a group consisting of oxalate, and one or more of humates, humate decomposition products, metals, acetate, formate, sulfate, chloride, fluoride, phosphate and combinations thereof.

Then, optionally the primarily organic phase exit stream 35 from the stripping stage 30 is carried forward to the regeneration stage 40 for intermixing with a regeneration solution input stream 42 in the regeneration stage 40 and then is allowed to undergo phase separation to form a primarily organic regeneration phase 44 and a primarily aqueous regeneration phase 46 which are at least partly immiscible in each other. Then the primarily organic stripping phase 44 discharges as a primarily organic phase exit stream 45. Meanwhile the primarily aqueous stripping-phase 46 discharges as the primarily aqueous regeneration exit stream 48.

Thus, the regeneration stage 40 intermixes the impurity reduced organic salt solution (the primarily organic phase exit stream 35 from the stripping stage 30) and a wash solution (regeneration solution input stream 42) in the regeneration stage 40 provided in an amounts effective to form a biphasic mixture that is allowed to undergo phase separation to form a washed organic salt phase (the primarily organic regeneration phase 44) and a primarily wash solution phase (primarily aqueous regeneration phase 46. Typically, the separated impurity reduced organic salt solution is intermixed with the wash solution at a mass ratio of separated reduced concentration phase to wash solution in a range between [1:100] to [1:0.01]. Typically, the wash solution (regeneration solution input stream 42) comprises an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF²]⁻), tetrafluoroborate, and hexafluorophosphate.

After the final separation from the regeneration solution the primarily organic phase exit stream 45 is recycled back to the beginning of the process.

In the specification the term primarily organic phase means more than 50% of the organic phase, preferably more than 80% of the organic phase, is organic salt.

In the specification the term primarily aqueous phase means more than 50% of the aqueous phase, preferably more than 80% of the aqueous phase, is water.

In certain aspects, the liquid phase extractant comprises an oxalate-extracting amount of an organic salt. Such oxalate-extracting amounts may be determined by routine experimentation informed by the guidance provided herein. The liquid phase extractant may comprise various amounts of the organic salt, (e.g., about 2% or greater, about 3% or greater, from about 3% to about 100%, about 5% or greater), by weight based on total weight of the liquid phase. The liquid phase may be an aqueous liquid phase. For example, in an embodiment the liquid phase comprises from about 1% to about 97% water, by weight based on total weight of aqueous liquid phase. The liquid phase may also contain diluents such as alcohols (e.g., isopropanol), polyols and/or polyethylene oxide. Such diluents may facilitate phase separation and/or inhibit gibbsite crystallization. Various amounts of diluents may be included in the liquid phase (e.g., from about zero to about 90%, about 0 to about 70%), by weight based on total weight of liquid phase. The liquid phase may also further comprise a solvent. Solvents useful in the liquid phase include, but are not limited to, aromatic hydrocarbons, some examples of which include toluene, benzene and derivatives thereof and light aromatic hydrocarbon oil (SX-12); aliphatic alcohols, some examples of which include 1-hexanol, 1-heptanol, 1-octanol and their respective derivatives; aromatic alcohols, examples of which include phenol and derivatives; and halogenated hydrocarbons, examples of which include methylene chloride and chloroform. Various amounts of solvents may be included in the liquid phase (e.g., from about zero to about 90%, about 0 to about 70%), by weight based on total weight of liquid phase.

The separation into a biphasic mixture in solvent extraction stage 20, stripping stage 30, regeneration stage 40 comprising an organic phase and an aqueous phase may be facilitated by any suitable method. Factors that tend to influence miscibility include, but are not limited to, temperature, the salt content of the industrial process stream, organic salt content of the organic salt solution, and various characteristics of the organic salt itself, such as molecular weight and chemical structure.

Useful mass ratios of organic salt solution to industrial process stream that are effective to form biphasic mixtures are typically in the range of about [1:100] to about [1:0.01] by weight. In another embodiment, the weight ratio of organic salt solution to industrial process stream is between about [1:10] to about [1:0.1]. In yet a further embodiment, the weight ratio of organic salt solution to industrial process stream is between about [1:4] to about [1:0.15]. In a further embodiment, the weight ratio of organic salt solution to industrial process stream is about [1:2] to about [1:0.25]. Routine experimentation informed by the guidance provided herein may be used to identify relative amounts of organic salt solution and industrial process stream that are effective to form biphasic mixtures.

The industrial process stream and the organic salt can be intermixed in various ways, e.g., by batch, semi-continuous or continuous methods. In one embodiment, the process is a continuous process. For example, the phase separation and recovery can be accomplished by feeding the industrial process stream and the organic salt into any suitable equipment that can be used for mixing and phase separation or settling. Examples of mixing and phase separation or settling equipment that may be suitable in particular situations may include, but is not limited to, continuous mixer/settler units, static mixers, in-line mixers, columns, centrifuges, and hydrocyclones. Routine experimentation informed by the guidance provided herein may be used to identify and select suitable equipment and operating conditions for particular situations.

In the present invention, extraction and stripping may be carried out in mixer settlers, columns, centrifuges, static mixers, reactors or other suitable contacting/separation equipment. The process may contain one or more extraction stages, one or more stripping stages, and may or may not include wash (regeneration)/scrub stages to remove impurities and reduce entrainment contamination. The extraction plant can be configured for series, modified-series, series parallel, modified series parallel, parallel, or interlaced series parallel operation for each section of the solvent extraction (“SX”) circuit (i.e. extraction section, scrub/wash section, and the stripping section). Alternatively, the extraction, scrubbing and stripping stages may be done on a batch basis.

The resulting biphasic mixture may be a liquid/liquid biphasic mixture or a solid/liquid biphasic mixture depending on the organic salt and the impurities present in the industrial process stream. In one embodiment, the biphasic mixture contains a primarily industrial process stream phase and a primarily organic salt solution.

Once the phases are separated, the organic phase can be recovered by conventional liquid-liquid separation techniques such as decantation, centrifugation, coalescence, filtration, distillation, and adsorption/desorption techniques.

### Additional Organic Phase Recovery

The present invention broadly relates to methods for efficiently recovering the organic salts (also known as ionic liquids, or organic salts comprising a quaternary organic cation) from the one or more aqueous exit streams resulting from the processing to obtain alumina. For example, the method of the invention may treat one or more of the following exit streams: (i) a treated Bayer process solution, (ii) a stripping stage exit solution, and (iii) a regeneration exit stream.

Any process for obtaining alumina, particularly any process for obtaining alumina which involves contacting alumina or bauxite with an aqueous phase, is applicable. Examples of such processes include the Bayer process, the Sinter process, as well as various combinations and modifications thereof. For example, the Bayer process for obtaining alumina from bauxite is a multi-step, continuous process, comprising grinding, pre-desilication, digestion, decantation, filtration, precipitation and calcination.

In the invention, one or more of the aqueous exit streams containing organic salt is treated with an inorganic salt. The inorganic salt is added in an effective amount to induce phase separation, e.g., to induce separation of the treated exit stream into at least one separate organic phase and at least one separate aqueous phase.

By “exit stream” is meant any effluent stream from the recycling of the organic salt, e.g., the various extraction, stripping and regeneration operations used in an industrial process to recover, purify or regenerate an ionic liquid. For example, in a process for recycling the organic salts, the organic salt is normally in the organic phase, which is carried forward in the process, while the aqueous phase (or “exit stream”) is considered a waste stream. Improvements to the overall yield may be achieved by using one or more of the various exit streams. Preferably, all exit streams would be treated to maximize recovery of the organic salt. Furthermore, it is permissible to treat each exit stream individually or combine the exit streams and perform on treatment on the combined streams using the inorganic salt.

The present invention allows for the treatment of these aqueous exit streams to recover the organic phase that would be lost if using methods from the prior art.

In accordance with the invention, described herein are methods for the treatment of one or more aqueous exit streams as a byproduct produced while the recycling of the organic salts to recover portions of the organic salts in these aqueous exit streams. In the methods described here, the exit streams may contain up to 10% of the organic salts, which would otherwise be lost. In certain aspects, the exit streams may contain about 20 to about 500 ppm of the organic salts, which would otherwise be lost. In certain aspects, the exit streams may contain about 1000 ppm of the organic salts, which would otherwise be lost.

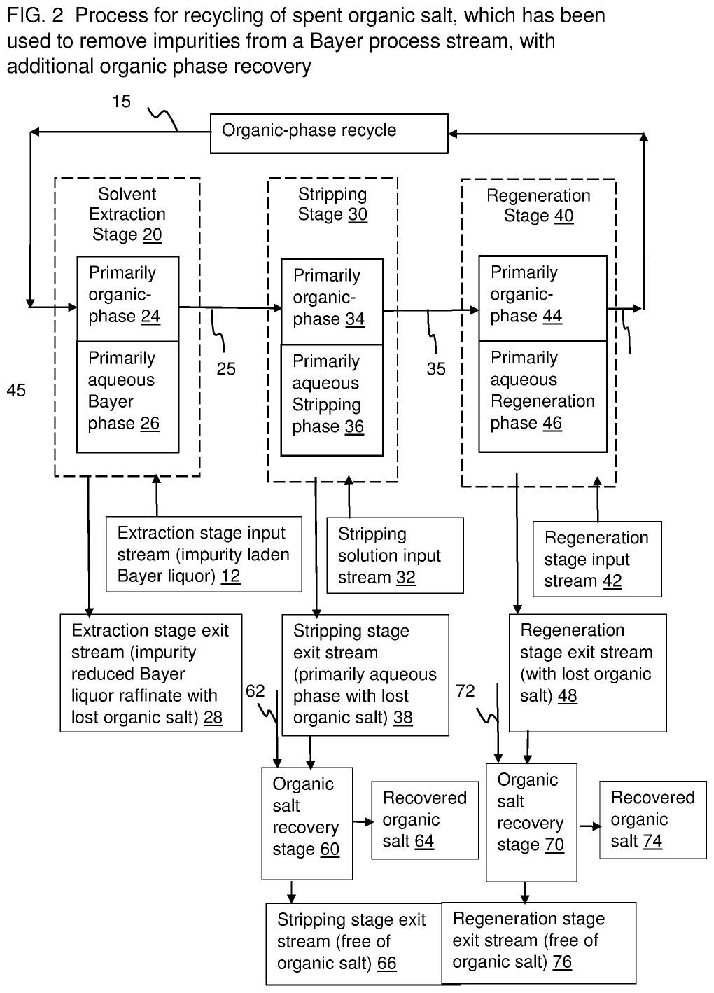

FIG. 2 is a flowchart showing a method of the invention for recycling and recovery of spent organic salts, which includes extraction, stripping and regeneration operations, with additional organic phase recovery of the present invention for treating exit streams with organic salts, to provide improved recovery of organic acids.

FIG. 2 shows the process of FIG. 1 modified to incorporate the present invention. FIG. 2 shows further processing the exit streams by adding an inorganic salt to one or more aqueous exit streams to form a biphasic mixture of the organic salt and the aqueous stream and induce phase separation of the organic salt from the remainder of the aqueous stream and letting a phase of the biphasic mixture containing the organic salt separate or, if desired to speed up the process, actively separating the phase containing the organic salt from the remainder of the aqueous exit stream. The organic phase containing the organic salt can then be separated (recovered) from the remainder of the aqueous stream of the biphasic mixture by liquid-liquid separation techniques such as decantation, centrifugation, coalescence, filtration, distillation, and adsorption/desorption techniques.

In particular, FIG. 2 shows sending the stripping stage exit stream 38 and an inorganic salt stream 62 to an organic salt recovery stage 60 to form a biphasic mixture and induce phase separation of the organic salt from the remainder of the aqueous stream and letting a phase of the biphasic mixture containing the organic salt separate or, if desired to speed up the process, actively separating the phase containing the organic salt from the remainder of the aqueous exit stream, to form a recovered organic salt stream 64 and an aqueous extraction stage exit stream (free of organic salt) 66. The actively separating the phase containing the organic salt from the remainder of the aqueous exit stream, to form the recovered organic salt stream 64 and the aqueous extraction stage exit stream (free of organic salt) 66 may be accomplished by liquid-liquid separation techniques such as decantation, centrifugation, coalescence, filtration, distillation, and adsorption/desorption techniques. Preferably, the addition of the inorganic salt allows the two phases to separate on their own.

FIG. 2 also shows sending the regeneration stage exit stream 48 and an inorganic salt stream 72 to an organic salt recovery stage 70 to form a biphasic mixture and induce phase separation of the organic salt from the remainder of the aqueous stream and letting a phase of the biphasic mixture containing the organic salt separate or, if desired to speed up the process, actively separating the phase containing the organic salt from the remainder of the aqueous exit stream, to form a recovered organic salt stream 74 and an aqueous extraction stage exit stream (free of organic salt) 76. Once the phases are separated, the organic phase can be recovered by conventional liquid-liquid separation techniques such as decantation, centrifugation, coalescence, filtration, distillation, and adsorption/desorption techniques.

In the invention the inorganic salt may be added as a solid, or as a solution in a suitable solvent.

The inorganic salt 52, 62, 72 and the respective aqueous exit stream 28, 38, 48 can be intermixed in various ways, e.g., by batch, semi-continuous or continuous methods. In one embodiment, the process is a continuous process. For example, the phase separation and recovery can be accomplished by feeding the inorganic salt 52, 62, 72 and the respective aqueous exit stream 28, 38, 48 into any suitable equipment that can be used for mixing and phase separation or settling. Examples of mixing and phase separation or settling equipment that may be suitable in particular situations may include, but is not limited to, continuous mixer/settler units, static mixers, in-line mixers, columns, centrifuges, and hydrocyclones. Routine experimentation informed by the guidance provided herein may be used to identify and select suitable equipment and operating conditions for particular situations.

In the present invention, the inorganic salt 52, 62, 72 and the respective aqueous exit stream 28, 38, 48 can be intermixed in mixer settlers, columns, centrifuges, static mixers, reactors or other suitable contacting/separation equipment. The process may contain any one or more of the organic salt recovery stage 50, the organic salt recovery stage 60, and/or the organic salt recovery stage 70. The process may contain one or more organic salt recovery stages 50. The process may contain one or more organic salt recovery stages 60. The process may contain one or more organic salt recovery stages 70. Each organic salt recovery stage 50, 60, 70 can independently be configured for series, modified-series, series parallel, modified series parallel, parallel, or interlaced series parallel operation for each section of the solvent extraction (“SX”) circuit. Alternatively, each organic salt recovery stage 50, 60, 70 can independently be done on a batch basis.

The resulting biphasic mixture in each organic salt recovery stage 50, 60, 70 may be a liquid/liquid biphasic mixture or a solid/liquid biphasic mixture depending on the organic salt and the impurities present in the respective aqueous exit stream 28, 38, 48.

The separation into a biphasic mixture in each organic salt recovery stage 50, 60, 70 may be facilitated by any suitable method. Factors that tend to influence miscibility include, but are not limited to, temperature, the inorganic salt content of the biphasic mixture, organic salt content of the biphasic mixture, and various characteristics of the inorganic salt and the organic salt itself, such as molecular weight and chemical structure.

In the invention the inorganic salt may be added in an amount of as much as its solubility limit, which can be determined for each system. Inorganic salt concentration is typically used in amounts of from about 0.1 to about 50 weight percent, or about 0.5 to about 50 weight percent, based on weight of aqueous medium, for example in amounts of from about 0.5 to about 20 weight percent, or about 1 to about 10 weight percent or about 3 to about 9 weight percent.

In the invention typically the inorganic salt in (c) is added in an amount to be from about 0.1 to about 50 wt. %, preferably 0.5 to about 20 wt. %, more preferably about 1 to about 10 wt. percent, most preferably about 3 to about 9 wt. percent, of the biphasic mixture. The lower limit of the amount inorganic salt that may be added in (c) may be about 0.1, about 0.5, about 1 or about 3 wt. % of the biphasic mixture. The upper limit of the amount inorganic salt that may be added in (c) may be about 50, about 20, about 10 or about 9 wt. % of the biphasic mixture.

The addition of the inorganic salt is effective to induce the phase separation, at which point it is possible to recover the organic salt, which is in the organic phase. In this regard, the separate organic phase may be recovered by a liquid-liquid separation technique. The liquid-liquid separation technique may be selected from decantation, centrifugation, coalescence, filtration, distillation, an adsorption/desorption techniques, or combinations thereof. In particular, the liquid-liquid separation technique may be a coalescence technique, which comprises passing the at least one exit stream through an inert coalescing media.

The methods described herein can be used to achieve very high levels of recovery of the organic salt, based on mass of total recovery from the combined organic extractions. For example, the method may be used to achieve at least 75% recovery of the organic salt, at least 80% recovery of the organic salt, at least 85% recovery of the organic salt, at least 90% recovery of the organic salt. As much as 95%, typically as much as 90%, of the lost organic extraction phase can be recovered. In certain embodiments, there is between about 50% recovery and about 90% recovery.

The present invention typically does not lower the temperature of the aqueous exit stream 28, 38, 48 to induce phase separation.

The present invention prior to organic salt recovery stage 50, 60, 70 typically does not pre-treat (filter/concentrate) the Ionic Liquid (IL) solution of aqueous exit stream 28, 38, 48. There typically is not a filtration step, however its possible there may be certain instances.

The method of the present invention typically recovers the organic liquid with an absence of additional methods of regeneration of certain organic salts such as, but are not limited to, use of supercritical carbon dioxide, pervaporation, distillation of impurities, use of alkaline solutions, electrolysis, and nanofiltration.

After the organic salt has been recovered by the invention, it is preferably recycled back into the process for the production of alumina.

### Aqueous Liquid Phase

The aqueous liquid phase being treated typically comprises from about 1% to about 97% water, by weight based on total weight of aqueous liquid phase.

### Organic Salts (Also Known as Ionic Liquids)

The organic salt used in the present invention comprises:

a cation selected from the group consisting of phosphonium, ammonium, sulfonium, imidazolium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium.

The organic salt used in the present invention organic salt comprises:

an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

Exemplary organic salts (ionic liquids) for use in the invention include those described in U.S. Pat. Nos. 8,435,411 and 7,972,580, which are hereby incorporated by reference in its entirety.

An ionic liquid (IL) is an organic salt in the liquid state. For purposes of the present specification the term is defined as organic salts whose melting point is below 100° C. (212° F.). Preferably the ionic liquid (IL) is an organic salt whose melting point is below 25° C. (77° F.). While ordinary liquids such as water and gasoline are predominantly made of electrically neutral molecules, ionic liquids are largely made of ions and short-lived ion pairs. An ionic liquid is a salt in which the ions are poorly coordinated, which results in these solvents being liquid below 100° C., or even at room temperature (room temperature ionic liquids, RTIL's). While ordinary liquids such as water and gasoline are predominantly made of electrically neutral molecules, ionic liquids are largely made of ions and short-lived ion pairs. These substances are variously called liquid electrolytes, ionic melts, ionic fluids, fused salts, liquid salts, or ionic glasses. At least one ion has a delocalized charge and one component is organic, which prevents the formation of a stable crystal lattice. The methylimidazolium and pyridinium ions are typically used for the development of ionic liquids. Properties, such as melting point, viscosity, and solubility of starting materials and other solvents, are determined by the substituents on the organic component and by the counterion.

The absence of volatility is one of the most important benefits of ionic liquids, offering a much lower toxicity as compared to low-boiling-point solvents. Ionic liquids.

The organic salt may comprise a quaternary organic cation. In certain aspects, the quaternary organic cation is selected from the group consisting of phosphonium, ammonium, imidazolium, pyrrolidinium, quinolinium, pyrazolium, oxazolium, thiazolium, isoquinolinium, and piperidinium.

The organic salt is preferably selected from a group consisting of: octyl(tributyl) phosphonium chloride, 1-octyl-2,3-dimethylimidazolium chloride, 1-butyl-3-methylimidazolium chloride, 1-butyl-2,3-dimethylimidazolium chloride, butylmethylpyrolidinium, octyl(tributyl)phosphonium hydroxide, tetrabutylphosphonium hydroxide, tetrabutylammonium hydroxide, tetradecyl(tributyl)phosphonium chloride, octyl(tributyl)ammonium chloride, tetradecyl(trihexyl) phosphonium bromide, tetrahexylammonium chloride, tributyl(hexyl) phosphonium chloride, tetradecyl(trihexyl)phosphonium chloride, tetrabutylphosphonium chloride, tetrabutylphosphonium chloride, tributylmethylammonium hydroxide, tetrapentylammonium hydroxide, dimethyl dicoco quaternary ammonium chloride, stearamidopropyldimethyl-2-hydroxyethyl ammonium nitrate, ethyltetradecyldiundecyl ammonium chloride, tallowalkyltrimethyl ammonium chloride, tetrahexylammonium bromide, butylmethylpyrrolidinium bis(trifluoromethylsulfonyl)imide, N,N,N-trimethyl-1-dodecanaminium chloride, benzyldimethylcocoalkylammonium chloride, N,N-dimethyl-N-dodecylglycine betaine, 1-octyl-2,3-dimethylimidazolium chloride, tributyl-8-hydroxyoctylphosphonium chloride, tetrapentylphosphonium hydroxide and combinations thereof.

A preferred quaternary organic cation is phosphonium. Preferably, the organic salt comprises an alkyl phosphonium salt.

The organic salt may be at least one alkyl phosphonium salt selected from the group consisting of trihexyltetradecylphosphonium chloride, tetrabutylphosphonium chloride, tetradecyl(tributyl)phosphonium chloride, tributyl (8-hydroxyoctyl)phosphonium chloride, Tri(isobutyl)Octylphosphonium chloride, and octyl(tributyl)phosphonium.

For example, the alkyl phosphonium salt may preferably be selected from tri butyl octyl phosphonium chloride and tri(isobutyl)Octylphosphonium chloride.

Another preferred quaternary organic cation is ammonium.

Preferably, the organic salt is selected from the group consisting of tetrabutylammonium hydroxide, tetrabutylammonium chloride, stearamidopropyldimethyl-2-hydroxyethylammonium nitrate, ethyltetradecyldiundecyl ammonium chloride, tetrahexylammonium bromide, dodecyltrimethyl ammonium chloride, benzyldimethylcoco ammonium chloride, N,N-dimethyl-N-dodecylglycine betaine, Adogen 462® (a dicoco dimethyl ammonium chloride quaternary supplied at 75% actives in IPA. CAS #61789-77-3), Aliquat® HTA-1 (quaternary ammonium salt), and tallowalkyltrimethyl ammonium chloride.

Preferably, the quaternary organic cation is selected from the group consisting of:

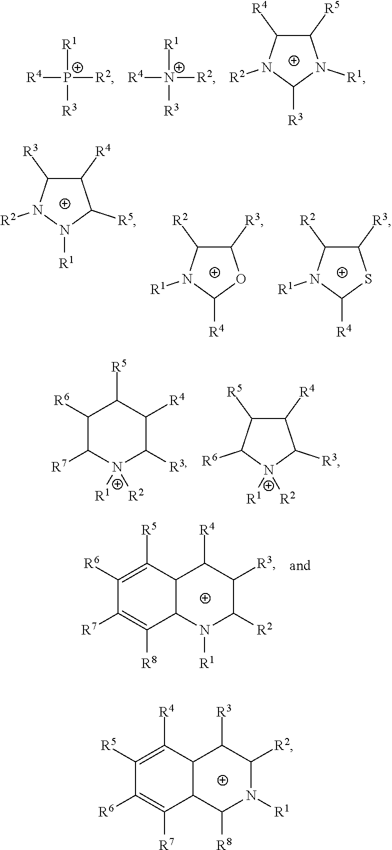

wherein R¹ through R⁸ are each independently hydrogen or an optionally substituted C₁-C₅₀ alkyl group, where the optional substituents are selected from alkyl, alkenyl, alkynyl, alkoxyalkyl, carboxylic acid, alcohol, carboxylate, hydroxyl, and aryl.

### Inorganic Salts

An “inorganic salt” is an ionic compound, composed of one or more cation and anions, which overall are electrically neutral (no net charge) and do not comprise carbon. Inorganic salts are generally composed of a metal ion (cation) and a non-metal ion (anion) in simple binary salts (two different atoms). In ternary salts (more than 2 different atoms) a metal ion may combine with a polyatomic anion.

Any suitable inorganic salt may be used in the methods described. The inorganic salt is added in an effective amount to induce phase separation, e.g., to induce separation of the treated exit stream into at least one separate organic phase and at least one separate aqueous phase.

The inorganic salt may comprise an anion, wherein the anion is selected from the group consisting of citrate³⁻, sulfate²⁻, phosphate³⁻, OH⁻, F⁻, Cl⁻, Br⁻, I⁻, NO₃⁻, ClO₄⁻, and mixtures thereof.

The inorganic salt may comprises a cation, wherein the cation is selected from the group consisting of N(CH₃)⁴⁺, NH₄⁺, Cs⁺, Rb⁺, K⁺, Na⁺, Li⁺, H⁺, Ca⁺², Mg²⁺, Al³⁺, and mixtures thereof.

Preferably, the inorganic salt is selected from the group consisting of sodium carbonate, sodium hydroxide, and mixtures thereof.

Preferably, the inorganic salt is selected from the group consisting of NaNO₂, sodium phosphates, potassium salts, aluminum salts and mixtures thereof.

Preferably, the inorganic salt is a potassium salt selected from the group consisting of K₃PO₄, K₂PO₄, K₂CO₃, and mixtures thereof.

The water-soluble inorganic salt contains mono- and/or di-valent and/or trivalent ions. Thus, the dissolved inorganic salt separates into mono- and/or di-valent and/or trivalent cations and anions, which disperse uniformly through the aqueous exit stream. The inorganic salt may be selected from at least one member of the group consisting of ions such as inorganic monovalent salts, divalent salts and trivalent salts, wherein the inorganic monovalent salts have a formula A+B−, wherein A is an alkali metal and B is a halogen. Monovalent salts have a typical formula A⁺B⁻, wherein A is selected from the group consisting of sodium, potassium or other alkali metals and B is selected from the group consisting of chloride, bromide or other halogens. The divalent inorganic salts have a formula Aₐ^{+X}B_{b}^{-Y}, wherein A is selected from the group consisting of calcium, magnesium, ferrous iron and B is selected from the group consisting of chloride, bromide, sulfate, carbonate, nitrate and a times X is +2 and b times Y is −2. The trivalent inorganic salts have the formula Aₐ^{+X}B_{b}^{-Y}, wherein A is selected from the group consisting of ferric iron and B is selected from the group consisting of chloride, bromide, sulfate, carbonate and nitrate and a times X is +3 and b times Y is −3. Suitable inorganic mono- and/or di-valent electrolytes include sodium sulfate, sodium nitrate, sodium chloride (which is preferable due to its availability and cost), sodium tripolyphosphate, sodium carbonate, magnesium chloride or potassium chloride, etc. but the monovalent metallic salts, particularly sodium chloride are preferred. Other electrolytes may also be present in combination with the sodium chloride.

To facilitate a better understanding of the present invention, the following examples of preferred or representative embodiments are given. In no way should the following examples be read to limit, or to define, the scope of the invention.

### EXAMPLE 1

### Ionic Liquid Recovery Measurements

Two stripping solutions, namely Control 1 and Control 2, were placed in the oven to maintain the temperature at 60° C. and to allow for any solid material to settle. Composition of Control 1 was 20% NaHCO₃ aqueous slurry with about 1761 ppm of tributyloctylphosphonium chloride. Composition of Control 2 was 20% NaHCO₃ aqueous slurry with about 2055 ppm of tributyloctylphosphonium chloride

Next, 10 mL aliquots of the stripping test solution containing Tri(butyl)Octylphosphonium chloride as the organic salt were removed via syringe and massed into 4 dram vials. A known mass of the stripping test solution was added to a 4 dram vial and shaken by hand to mix and dissolve any solid material. Upon addition, the samples became cloudy, or turbid, indicating that the organic salt had precipitated or separated out from the bulk aqueous solution. The samples were placed in the oven at 60° C. for 2-4 hours to allow the phases to completely disengage.

Aqueous test samples are then removed via syringe to not contaminate with extraction phase droplets that float on the top of the test sample. The sample was then analyzed via elemental analysis for phosphorous. The results are summarized in TABLE I.

TABLE I

| | | | % Inorganic | ppm | |
|---|---|---|---|---|---|
| | | | Salt | Organic | |
| | | | (additive) in | Salt in | |
| Stripping | Inorganic | | resulting | resulting | |
| test | Salt | | Strip | Strip | % |
| solution | (additive) | Added as | Solution | solution | Recovered |
| Control 1 | — | | — | 1761 | — |
| 1 | Na2SO4 | 20% solution | 3.4% | 1162 | 34% |
| 1 | NaOH | 50% solution | 4.5% | 783 | 56% |
| 1 | Na2SO4 | solid | 9.2% | 726 | 59% |
| 1 | NaNO3 | 30% solution | 2.2% | 702 | 60% |
| 1 | NaOH | 50% solution | 8.4% | 529 | 70% |
| Control 2 | — | | — | 2055 | — |
| 2 | Na2SO4 | 20% solution | 3.3% | 1863 | 9% |
| 2 | NaNO3 | 30% solution | 2.2% | 703 | 66% |
| 2 | Na2SO4 | solid | 9.1% | 403 | 80% |
| 2 | NaOH | 50% solution | 4.6% | 360 | 82% |
| 2 | NaOH | solid | 9.5% | 277 | 87% |
| 2 | Na2CO3 | solid | 13.0% | 194 | 91% |
| 2 | NaOH | 50% solution | 8.5% | 116 | 94% |

TABLE I shows the inorganic salt used as an additive, as well as its wt. % concentration as a percentage of added inorganic salt in total sample (10 g test solution+test solution). “Control 1” and “Control 2” are the initial test solutions. % Recovered was calculated based on the reduction of the concentration of phosphonium Ionic Liquid in the aqueous phase

The results indicate that up to 94% of the lost organic extraction phase can be recovered.

As used herein, the terms “a” and “an” do not denote a limitation of quantity, but rather the presence of at least one of the referenced items. “Or” means “and/or” unless clearly indicated to the contrary by the context.

Recitation of ranges of values are merely intended to serve as a shorthand method of referring individually to each separate value falling within the range, and each separate value is incorporated into this specification as if it were individually recited. Thus each range disclosed herein constitutes a disclosure of any sub-range falling within the disclosed range. Disclosure of a narrower range or more specific group in addition to a broader range or larger group is not a disclaimer of the broader range or larger group. All ranges disclosed herein are inclusive of the endpoints, and the endpoints are independently combinable with each other.

“Comprises” as used herein includes embodiments “consisting essentially of” or “consisting of” the listed elements.

In the context of the present specification the term “about” means within round off. For example, about 1 includes 1.4, and about 1.0 includes 1.04. Where a number is prefaced with the term “about” the inventors also contemplate the number without the term “about” as being within their invention.

### CLAUSES OF THE INVENTION

The following clauses describe typical aspects of the present invention.

Clause 1. A method for separating at least one organic salt from an aqueous phase, the method comprising:
providing an aqueous phase, wherein the aqueous phase comprises at least one organic salt and wherein the at least one organic salt is soluble in the aqueous phase;
intermixing the aqueous phase with an amount of inorganic salt to form a biphasic mixture, wherein the intermixing is effective to reduce a concentration of organic salt in the aqueous phase; and
forming an organic salt reduced aqueous phase and a primarily organic salt phase,
wherein the organic salt present in the aqueous phase and the primarily organic salt phase comprises:
a cation selected from the group consisting of phosphonium, ammonium, sulfonium, imidazolium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium; and
an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

Clause 2. A method for recovering an organic salt in an industrial process for the production of alumina, comprising:

(a) contacting an organic liquid phase comprising at least one organic salt with an aqueous solution at least partially immiscible in the organic liquid phase to produce a biphasic liquid/liquid mixture comprising a primarily aqueous phase and a primarily organic salt phase, wherein the intermixing is effective to transfer a portion of the at least one organic salt to the primarily aqueous phase,
(b) at least partially separating the primarily aqueous phase from the primarily organic salt phase to form a separated primarily aqueous phase and a separated primarily organic salt phase; and
(c) intermixing the separated primarily aqueous phase with an amount of an inorganic salt to form a biphasic mixture, wherein the amount of inorganic salt is effective to form a recovered organic phase, comprising a recovered portion of said at least one organic salt, and a recovered aqueous phase,
wherein the inorganic salt has at least one anion selected from citrate³⁻, sulfate²⁻, phosphate³⁻, OH⁻, F⁻, Cl⁻, Br⁻, I⁻, NO₃⁻, ClO₄⁻ and at least one cation selected from N(CH₃)₄⁺, NH₄⁺, Cs⁺, Rb⁺, K⁺, Na⁺, Li⁺, H⁺, Ca⁺, Mg²⁺, Al³⁺; and
   (d) optionally recycling the recovered organic phase to the industrial process;
wherein the at least one organic salt comprises a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium, and an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

Clause 3. The method of clause 2, wherein one of said organic liquid phase and said aqueous solution comprises a first concentration of oxalate, and another of said organic liquid phase and said aqueous solution has a second concentration of oxalate which is an absence of oxalate or a lower concentration of oxalate than said first concentration of oxalate, wherein the intermixing is effective to transfer a portion of the oxalate from the phase having the first concentration of oxalate to the phase having the second concentration of oxalate.

Clause 4. The method of clause 3, comprising providing the organic liquid phase as an impurity-loaded organic salt solution comprising a first concentration of the oxalate; and providing the aqueous solution as a stripping solution,
intermixing the impurity-loaded organic salt solution with the stripping solution to form the biphasic mixture, wherein the intermixing is effective to reduce the first concentration of oxalate in the impurity-loaded organic salt solution, thereby removing impurities comprising said oxalate from the organic salt solution and
forming the primarily organic salt phase as an impurity reduced organic salt solution phase and the primarily aqueous phase as a primarily stripping solution phase.

Clause 5. The method of clause 2, wherein the inorganic salt is present in an effective amount to induce phase separation of the recovered organic phase and the recovered aqueous phase.

Clause 6. A method for recovering an organic salt in a process for the production of alumina, comprising:

(a) contacting an organic salt liquid phase comprising at least one organic salt with an aqueous process stream of a process for the production of alumina for the removal of at least one impurity from the aqueous process stream and transfer of the at least one impurity to a primarily organic phase comprising the organic salt and the at least one impurity, and producing an impurity laden organic salt stream comprising the primarily organic phase, wherein the at least one impurity comprises oxalate;
(b) recycling the organic salt, wherein the recycling comprises removing at least a portion of the at least one impurity from the impurity laden organic salt stream, wherein the contacting and/or the recycling generate at least one aqueous exit stream which comprises a portion of the organic salt from the organic salt liquid phase;
(c) intermixing the at least one aqueous exit stream with an amount of an inorganic salt to form a biphasic mixture and allowing the biphasic mixture to form an organic salt reduced aqueous solution phase and a primarily organic salt phase, wherein the amount of the inorganic salt in the biphasic mixture is effective to form the organic salt reduced aqueous solution phase and a primarily organic salt phase, wherein the primarily organic salt phase comprises the portion of the organic salt; and
(d) recovering the primarily organic salt phase;
wherein the at least one organic salt comprises a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium, and an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF₂]⁻), tetrafluoroborate, and hexafluorophosphate.

Clause 7. The method of clause 6, further comprising the step of performing at least one additional purification operation on the separated primarily organic salt phase.

Clause 8. The method of clause 6, wherein the recovered primarily organic salt phase is recycled back into the process for the production of alumina.

Clause 9. The method of any of clauses 1 to 6, wherein the process for the production of alumina is selected from the a Bayer process or a Sinter process

Clause 10. The method of clause 6, wherein recycling the organic phase comprising the at least one organic salt generates at least one exit stream which is the aqueous solution comprising a portion of the organic salt.

Clause 11. The method of clause 6, wherein the recycling in (b) comprises one or more of an extraction stage, a stripping stage and a regeneration stage.

Clause 12. The method of clause 6, wherein the at least one exit stream in (b) is selected from the group consisting of a treated Bayer process solution, a stripping stage exit solution, a regeneration exit stream, and mixtures thereof.

Clause 13. The method of clause 6, wherein the portion of the organic salt in (b) is entrained in an immiscible phase of the aqueous exit stream.

Clause 14. The method of clause 6, wherein the aqueous process stream is a Bayer process stream,
wherein the organic salt liquid phase includes at least 1 wt. % said organic salt, based on the weight of the Bayer process stream,
wherein the organic salt comprises a quaternary organic cation,
wherein the organic liquid phase is at least partially immiscible with the Bayer process stream, and
wherein the Bayer process stream intermixes with the organic liquid phase in an amount effective to form the biphasic liquid/liquid mixture, wherein the biphasic liquid/liquid mixture comprises the primarily aqueous phase as a primarily Bayer process phase and the primarily organic salt phase; and
at least partially separating the primarily Bayer process phase from the primarily organic salt phase to form the separated primarily aqueous phase as a separated primarily Bayer process phase having a reduced oxalate concentration and the separated primarily organic salt phase, wherein the intermixing is effective to reduce the concentration of oxalate in the Bayer process stream by extraction from the Bayer process stream into the primarily organic salt phase.

Clause 15. The method of any of clauses 1 to 6, wherein the organic salt comprises at least one quaternary organic cation selected from the group consisting of phosphonium, ammonium, imidazolium, pyrrolidinium, quinolinium, pyrazolium, oxazolium, thiazolium, isoquinolinium, and piperidinium.

Clause 16. The method of clause 15, wherein the quaternary organic cation is phosphonium.

Clause 17. The method of clause 16, wherein the organic salt is selected from the group consisting of trihexyltetradecylphosphonium chloride, tetrabutylphosphonium chloride, tetradecyl(tributyl)phosphonium chloride, tributyl (8-hydroxyoctyl)phosphonium chloride and octyl(tributyl)phosphonium.

Clause 18. The method of clause 15, wherein the quaternary organic cation is ammonium.

Clause 19. The method of clause 18, wherein the organic salt is selected from the group consisting of tetrabutylammonium hydroxide, tetrabutylammonium chloride, stearamidopropyldimethyl-2-hydroxyethylammonium nitrate, ethyltetradecyldiundecyl ammonium chloride, tetrahexylammonium bromide, dodecyltrimethyl ammonium chloride, benzyldimethylcoco ammonium chloride, N,N-dimethyl-N-dodecylglycine betaine, Adogen 462®, Aliquat® HTA-1, and tallowalkyltrimethyl ammonium chloride.

Clause 20. The method of clause 15, wherein the quaternary organic cation is selected from the group consisting of:

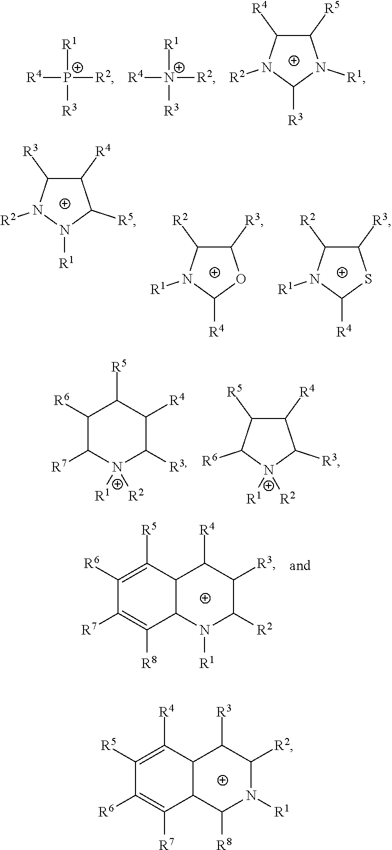

wherein R¹ through R⁸ are each independently hydrogen or an optionally substituted C₁-C₅₀ alkyl group, where the optional substituents are selected from alkyl, alkenyl, alkynyl, alkoxyalkyl, carboxylic acid, alcohol, carboxylate, hydroxyl, and aryl.

Clause 21. The method of any of clauses 1 to 6, wherein the inorganic salt is selected from the group consisting of sodium carbonate, sodium hydroxide, and mixtures thereof.

Clause 22. The method of any of clauses 1 to 6, wherein the inorganic salt is selected from the group consisting of NaNO₂, sodium phosphates, potassium salts, aluminum salts and mixtures thereof.

Clause 23. The method of any of clauses 1 to 6, wherein the inorganic salt is a potassium salt selected from the group consisting of K₃PO₄, K₂PO₄, K₂CO₃, and mixtures thereof.

Clause 24. The method of any of clauses 1 to 6, wherein the amount of the inorganic salt is from about 0.5 wt. % to about 20 wt. %, preferably about 1 wt. % to about 10 wt. %, most preferably about 3 wt. % to about 9 wt. %, of the biphasic mixture.

Clause 25. The method of any of clauses 1 to 6, wherein forming of the organic salt reduced aqueous phase and the primarily organic salt phase from the biphasic mixture is by a liquid-liquid separation technique.

Clause 26. The method of clause 23, wherein the liquid-liquid separation technique is selected from decantation, centrifugation, coalescence, filtration, distillation, an adsorption/desorption techniques, or combinations thereof.

Clause 27. The method of clause 23, wherein the liquid-liquid separation technique is a coalescence technique, and further comprises passing the at least one exit stream through an inert coalescing media.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1-5. (canceled)

6. A method for recovering an organic salt in a Bayer or Sinter process for the production of alumina, comprising:
(a) contacting an organic salt liquid phase comprising at least one organic salt with an aqueous process stream of the Bayer or Sinter process for the production of alumina for the removal of at least one impurity from the aqueous process stream and transfer of the at least one impurity to a primarily organic phase comprising the organic salt and the at least one impurity, and producing an impurity laden organic salt stream comprising the primarily organic phase, wherein the at least one impurity comprises oxalate;
(b) recycling the organic salt, wherein the recycling comprises removing at least a portion of the at least one impurity from the impurity laden organic salt stream, wherein the contacting and/or the recycling generate at least one aqueous exit stream which comprises a portion of the organic salt from the organic salt liquid phase;
(c) intermixing the at least one aqueous exit stream with an amount of an inorganic salt to form a biphasic mixture and allowing the biphasic mixture to form an organic salt reduced aqueous solution phase and a primarily organic salt phase, wherein the amount of the inorganic salt in the biphasic mixture is effective to form the organic salt reduced aqueous solution phase and a primarily organic salt phase, wherein the primarily organic salt phase comprises the portion of the organic salt; and
(d) recovering the primarily organic salt phase;
wherein the at least one organic salt comprises:
a cation selected from the group consisting of phosphonium, ammonium, sulfonium, pyridinium, pyridazinium, pyrimidinium, pyrazinium, pyrazolium, imidazolium, thiazolium, oxazolium, pyrrolidinium, quinolinium, isoquinolinium, guanidinium, piperidinium and methylmorpholinium, and
an anion selected from the group consisting of fluoride, chloride, bromide, iodide, hydroxyl, alkylsulfate, dialkylphosphate, sulfate, nitrate, phosphate, sulfite, phosphite, nitrite, hypochlorite, chlorite, chlorate, perchlorate, carbonate, bicarbonate, carboxylate, bis(trifluoromethylsulfonyl)imide ([NTF2]−), tetrafluoroborate, and hexafluorophosphate.

7. The method of claim 6, further comprising the step of performing at least one additional purification operation on the separated primarily organic salt phase.

8. The method of claim 6, wherein the recovered primarily organic salt phase is recycled back into the process for the production of alumina.

9. (canceled)

10. The method of claim 6, wherein recycling the organic phase comprising the at least one organic salt generates at least one exit stream which is the aqueous solution comprising a portion of the organic salt.

11. The method of claim 6, wherein the recycling in (b) comprises one or more of an extraction stage, a stripping stage and a regeneration stage.

12. The method of claim 6, wherein the at least one exit stream in (b) is selected from the group consisting of a treated Bayer process solution, a stripping stage exit solution, a regeneration exit stream, and mixtures thereof.

13. The method of claim 6, wherein the portion of the organic salt in (b) is entrained in an immiscible phase of the aqueous exit stream.

14. The method of claim 6, wherein the aqueous process stream is a Bayer process stream,
wherein the organic salt liquid phase includes at least 1 wt. % said organic salt, based on the weight of the Bayer process stream,
wherein the organic salt comprises a quaternary organic cation,
wherein the organic liquid phase is at least partially immiscible with the Bayer process stream, and
wherein the Bayer process stream intermixes with the organic liquid phase in an amount effective to form the biphasic liquid/liquid mixture, wherein the biphasic liquid/liquid mixture comprises the primarily aqueous phase as a primarily Bayer process phase and the primarily organic salt phase; and
at least partially separating the primarily Bayer process phase from the primarily organic salt phase to form the separated primarily aqueous phase as a separated primarily Bayer process phase having a reduced oxalate concentration and the separated primarily organic salt phase, wherein the intermixing is effective to reduce the concentration of oxalate in the Bayer process stream by extraction from the Bayer process stream into the primarily organic salt phase.

15. The method of claim 6, wherein the organic salt comprises at least one quaternary organic cation selected from the group consisting of phosphonium, ammonium, imidazolium, pyrrolidinium, quinolinium, pyrazolium, oxazolium, thiazolium, isoquinolinium, and piperidinium.

16. The method of claim 15, wherein the quaternary organic cation is phosphonium.

17. The method of claim 16, wherein the organic salt is selected from the group consisting of trihexyltetradecylphosphonium chloride, tetrabutylphosphonium chloride, tetradecyl(tributyl)phosphonium chloride, tributyl (8-hydroxyoctyl)phosphonium chloride and octyl(tributyl)phosphonium.

18. The method of claim 15, wherein the quaternary organic cation is ammonium.

19. The method of claim 18, wherein the organic salt is selected from the group consisting of tetrabutylammonium hydroxide, tetrabutylammonium chloride, stearamidopropyldimethyl-2-hydroxyethylammonium nitrate, ethyltetradecyldiundecyl ammonium chloride, tetrahexylammonium bromide, dodecyltrimethyl ammonium chloride, benzyldimethylcoco ammonium chloride, N,N-dimethyl-N-dodecylglycine betaine, Adogen 462®, Aliquat® HTA-1, and tallowalkyltrimethyl ammonium chloride.

20. The method of claim 15, wherein the quaternary organic cation is selected from the group consisting of: 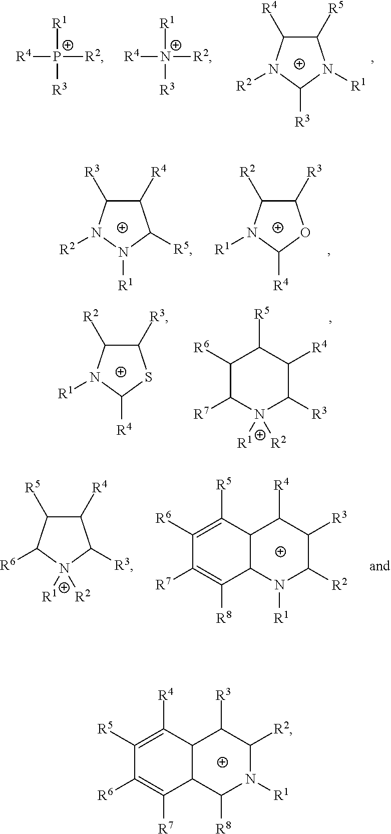
wherein each of R¹ through R⁸ is independently chosen from hydrogen or a C₁-C₅₀ alkyl group, optionally substituted with one or more substituents elected from alkyl, alkenyl, alkynyl, alkoxyalkyl, carboxylic acid, alcohol, carboxylate, hydroxyl, and aryl.

21. The method of claim 6, wherein the inorganic salt is selected from the group consisting of sodium carbonate, sodium hydroxide, and mixtures thereof.

22. The method of claim 6, wherein the inorganic salt is selected from the group consisting of NaNO₂, sodium phosphates, potassium salts, aluminum salts and mixtures thereof.

23. The method of claim 6, wherein the inorganic salt is a potassium salt selected from the group consisting of K₃PO₄, K₂PO₄, K₂CO₃, and mixtures thereof.

24. The method of claim 6, wherein the amount of the inorganic salt is from about 0.5 wt. % to about 20 wt. %, preferably about 1 wt. % to about 10 wt. %, most preferably about 3 wt. % to about 9 wt. %, of the biphasic mixture.

25. The method of claim 6, wherein forming of the organic salt reduced aqueous phase and the primarily organic salt phase from the biphasic mixture is by a liquid-liquid separation technique.

26. The method of claim 23, wherein the liquid-liquid separation technique is selected from decantation, centrifugation, coalescence, filtration, distillation, an adsorption/desorption techniques, or combinations thereof.

27. The method of claim 23, wherein the liquid-liquid separation technique is a coalescence technique, and further comprises passing the at least one exit stream through an inert coalescing media.
